(19) United States
(12) Patent Application Publication
(10) Pub. No.: US 2025/0328826 A1
(43) Pub. Date: Oct. 23, 2025

(54) SYSTEMS AND METHODS FOR FORECASTING ENERGY UTILIZATION

(71) Applicant: Walmart Apollo, LLC, Bentonville, AR (US)

(72) Inventors: Achala Sharma, Bangalore (IN); Ashish Gupta, Bangalore (IN); Priyanshu Ranjan, Bangalore (IN); Kartikeya Gupta, Bengaluru (IN); Rahul Ghosh, Bangalore (IN); Ankit Ajit Jain, Bangalore (IN); Atul Yadav, Sarjapur (IN)

(21) Appl. No.: 19/186,436

(22) Filed: Apr. 22, 2025

(30) Foreign Application Priority Data
Apr. 23, 2024 (IN) 202441031992

(51) Int. Cl. G06Q 10/04; H02J 3/00

(52) U.S. Cl. CPC G06Q 10/04; H02J 3/003; H02J 2203/20

(57) ABSTRACT

Systems and methods for forecasting energy utilization of charging stations to determine charging station allocation are disclosed. In some embodiments, a disclosed method includes: receiving a forecast request seeking utilization of electric vehicle (EV) charging stations at a location in a future time period; determining at least one EV related feature based on the forecast request; computing at least one forecasted feature value for the at least one EV related feature associated with the location in the future time period; generating, using a utilization model, forecasted utilization data based on the at least one forecasted feature value; and transmitting the forecasted utilization data to a computing device.

### CROSS REFERENCE TO RELATED APPLICATION

This application claims benefit to Indian Patent Application number 202441031992, entitled “SYSTEMS AND METHODS FOR FORECASTING ENERGY UTILIZATION,” filed on Apr. 23, 2024, the disclosure of which is incorporated herein by reference in its entirety.

### TECHNICAL FIELD

This application relates generally to charging station allocation and, more particularly, to systems and methods for forecasting energy utilization of charging stations to determine charging station allocation.

### BACKGROUND

An easy access to on-the-go charging stations is a game-changer for drivers who have been hesitant to purchase an electric vehicle (EV) due to concerns that they will be unable to locate a charger in a clean, bright, and secure location when desired. As such, a retailer, especially a large retail company, would like to have its own EV fast-charging network at store locations across the nation, to offer a convenient charging option that will make it possible for customers and members to own and charge EVs no matter where they live: in countryside, in suburbs, or in cities.

To determine the optimal locations for the construction of EV charging stations, it is imperative to have a long-term financial viability at such locations. An expected revenue from such stations is an important input to financial modeling, and expected utilization (e.g. sale of charging energy in kWh) is an important input to revenue estimation. Therefore, robust, reliable and accurate forecast of the long-term charging utilization of the extensive network of retail locations is crucial for location selection strategy for EV charging stations.

Some existing solutions focus on short-term (days to weeks) utilization forecast for energy load forecasting of EV charging stations or day to day operations planning at generic locations. These forecasts do not apply to a long-term forecast model, which is expected to extrapolate over scenarios never seen in training data since future EV adoption is at unprecedented levels compared to current adoption. Some methods for long term forecast are not applicable here because of their limitation of historical data.

### SUMMARY

The embodiments described herein are directed to systems and methods for forecasting energy utilization of charging stations, e.g. electric vehicle (EV) charging stations, to determine EV charging station allocation, e.g. at a retail location.

In various embodiments, a system including a non-transitory memory configured to store instructions thereon and at least one processor is disclosed. The at least one processor is operatively coupled to the non-transitory memory and configured to read the instructions to: receive, from a computing device, a forecast request seeking utilization of EV charging stations at a location in a future time period; determine at least one EV related feature based on the forecast request; compute at least one forecasted feature value for the at least one EV related feature associated with the location in the future time period; generate, using a utilization model, forecasted utilization data based on the at least one forecasted feature value; and transmit the forecasted utilization data to the computing device.

In various embodiments, a computer-implemented method is disclosed. The computer-implemented method includes: receiving, from a computing device, a forecast request seeking utilization of EV charging stations at a location in a future time period; determining at least one EV related feature based on the forecast request; computing at least one forecasted feature value for the at least one EV related feature associated with the location in the future time period; generating, using a utilization model, forecasted utilization data based on the at least one forecasted feature value; and transmitting the forecasted utilization data to the computing device.

In various embodiments, a non-transitory computer readable medium having instructions stored thereon is disclosed. The instructions, when executed by at least one processor, cause at least one device to perform operations including: receiving, from a computing device, a forecast request seeking utilization of EV charging stations at a location in a future time period; determining at least one EV related feature based on the forecast request; computing at least one forecasted feature value for the at least one EV related feature associated with the location in the future time period; generating, using a utilization model, forecasted utilization data based on the at least one forecasted feature value; and transmitting the forecasted utilization data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for forecasting energy utilization of charging stations, in accordance with some embodiments of the present teaching;

FIG. 2 is a block diagram of a utilization forecast computing device, in accordance with some embodiments of the present teaching;

FIG. 3 is a block diagram illustrating various portions of a system for forecasting energy utilization of charging stations, in accordance with some embodiments of the present teaching;

FIG. 4 illustrates an exemplary scheme of a utilization forecast model, in accordance with some embodiments of the present teaching;

FIG. 5 illustrates an exemplary process for forecasting features associated with a utilization forecast model, in accordance with some embodiments of the present teaching;

FIG. 6 illustrates an exemplary process for forecasting EV count at store neighborhood level, in accordance with some embodiments of the present teaching;

FIG. 7 illustrates an exemplary time series model with conditions and constrained features, in accordance with some embodiments of the present teaching;

FIG. 8 illustrates an exemplary framework for forecasting energy utilization of charging stations, in accordance with some embodiments of the present teaching;

FIG. 9 is a flowchart illustrating an exemplary method for forecasting energy utilization of charging stations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

While a robust and accurate forecast of long-term charging utilization is crucial for selecting a location for electric vehicle (EV) charging stations, a robust forecast model often needs to be developed with an abundance of historical data. The problem of long-term forecasting with a scarcity of historical data is a common challenge encountered in many domains. But this problem is exacerbated in the EV industry because of various factors. For example, changes in policies, changes in demographics, and fluctuations in economic situations all have the potential to influence the forecast in a rapidly evolving and nascent industry of EV and electric vehicles supply equipment (EVSE). One objective of various embodiments in the present teaching is to develop systems and methods for long term EV charging utilization forecast, particularly in scenarios characterized by the scarcity of data.

In some embodiments, the data available for utilization forecasting is scarce in many aspects. For example, history of charging is limited to a short time period, e.g. less than 2 years; charging utilization is available only at an aggregate monthly level for each location and not at granular session level; the number of existing locations is limited; and the existing locations are not spread out evenly across the nation, where some states are inadequately covered or not covered at all. A disclosed utilization model can handle these scarcities through synthetic data to provide capability to generate utilization data for a potential EV charging station for any given specifications at a retail location. This capability helps to train the utilization model for locations without any EV charging stations as of now.

The disclosed systems can generate synthetic data to augment limited number of observations and incorporate information from multiple heterogeneous internal and external sources. For EV charging utilization forecast, the historical feature values are often available at different levels of granularity (e.g. state code level EV sales available monthly vs. national level EV count available yearly). A disclosed forecasting method can integrate individual features at different granularities and provide a consistent and robust EV utilization forecast. In addition, the system can also incorporate external utilization forecasts from black box approaches to distil data insights to strengthen predictive power of the disclosed utilization model without losing interpretability and independence in method design.

In some embodiments, the disclosed system generates a time-series synthetic data conditioned on strategic features (e.g. location of a store, store sales, EV count in a geo-location) through custom enhancements in the machine learning objective function of a generative time-series model, e.g. a Time-series Generative Adversarial Network (TimeGAN) model, which relies on joint interactions of all features and hence are agnostic of relative importance of strategic features. The enhancements help to ensure that lack of history (e.g. fewer number of time samples) and lack of variety (e.g. limited number of geo-locations) do not affect the quality of synthetic data generation. In some embodiments, the disclosed system provides individual feature level loss minimization, in addition to a joint loss minimization for all features. This ensures that feature weights can be curated to reflect strategic importance of various features to provide more representative synthetic data samples.

In some embodiments, the long-term forecasting models use exclusively direct current fast charging (DCFC) as a target specification, and include specific information of retail customers and store transactions to provide customized utilization for retail stores, which can be generalized for estimating utilization for any retail location. In some embodiments, apart from contextualizing forecasting to retail locations, the system can also combine external heterogenous datasets available at different granularities (e.g. zip code-quarterly, national-yearly, etc.) to provide a robust forecast. The system demonstrates the capability to extract key information from external black box recommendations like state or national level EV or utilization forecasts, to update the disclosed store level utilization forecast models.

Furthermore, in the following, various embodiments are described with respect to systems and methods for forecasting energy utilization of charging stations to determine charging station allocation are disclosed. In some embodiments, a disclosed method includes: receiving, from a computing device, a forecast request seeking utilization of electric vehicle (EV) charging stations at a location in a future time period; determining at least one EV related feature based on the forecast request; computing at least one forecasted feature value for the at least one EV related feature associated with the location in the future time period; generating, using a utilization model, forecasted utilization data based on the at least one forecasted feature value; and transmitting the forecasted utilization data to the computing device.

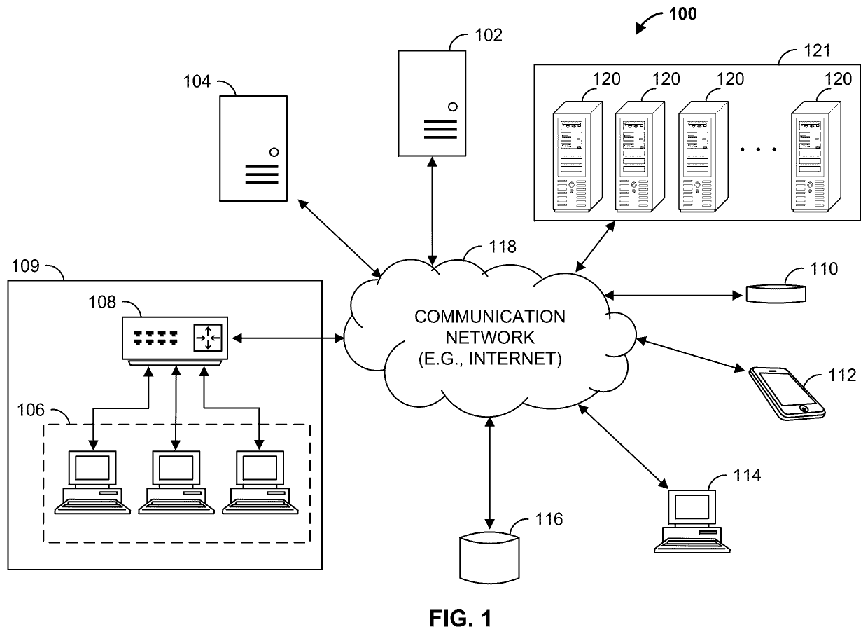

Turning to the drawings, FIG. 1 is a network environment 100 configured for forecasting energy utilization of charging stations to determine charging station allocation, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a utilization forecast computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The utilization forecast computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGA s), one or more application-specific integrated circuits (ASICs), one or more state machines, digital circuitry, or any other suitable circuitry. In addition, each can transmit and receive data over the communication network 118.

In some examples, each of the utilization forecast computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the utilization forecast computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the utilization forecast computing device 102, the processing devices 120, and/or the server 104 are operated by a retailer, and the multiple user computing devices 110, 112, 114 are operated by customers, advertisers, associates or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the utilization forecast computing device 102 over the communication network 118. The workstation(s) 106 may send data to, and receive data from, the utilization forecast computing device 102. For example, the workstation(s) 106 may transmit data identifying items purchased by a customer at the store 109 to the utilization forecast computing device 102. The workstation(s) 106 may also transmit other data related to the store 109 to the utilization forecast computing device 102.

Although FIG. 1 illustrates three user computing devices 110, 112, 114, the network environment 100 can include any number of user computing devices 110, 112, 114. Similarly, the network environment 100 can include any number of the utilization forecast computing devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may transmit user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the utilization forecast computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the utilization forecast computing device 102.

In some examples, the server 104 transmits to the utilization forecast computing device 102 a forecast request seeking expected energy utilization of EV charging stations at a location in a future time period. In some examples, the utilization forecast computing device 102 may execute one or more models (e.g., programs or algorithms), such as a machine learning model, deep learning model, statistical model, etc., to generate forecasted utilization data for the EV charging stations. The utilization forecast computing device 102 may determine one or more EV related features based on the forecast request, and compute a forecasted feature value for each EV related feature associated with the location in the future time period. The utilization forecast computing device 102 may generate, using a utilization model, the forecasted utilization data based on the forecasted feature values, where the utilization model may be a machine learning model. The utilization forecast computing device 102 may then transmit the forecasted utilization data to the server 104 to determine whether the location is a good choice to install a new EV charging station.

In some embodiments, the utilization forecast computing device 102 may also infer at least one key predictor of interest from an external utilization data. The utilization forecast computing device 102 may update the utilization model based on the at least one key predictor of interest, and/or transmit the at least one key predictor of interest to the server 104 for further insight analysis and/or business decisions.

In some embodiments, the utilization forecast computing device 102 is further operable to communicate with the database 116 over the communication network 118. For example, the utilization forecast computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the utilization forecast computing device 102, in some examples, the database 116 can be a local storage device, such as a hard drive, a non-volatile memory, or a USB stick. For example, the utilization forecast computing device 102 may store online purchase data received from the server 104 in the database 116. The utilization forecast computing device 102 may receive in-store purchase data and store related data from the store 109 and store them in the database 116. The utilization forecast computing device 102 may also receive from the server 104 user session data identifying events associated with browsing sessions, and may store the user session data in the database 116.

In some examples, the utilization forecast computing device 102 generates and/or updates different models (e.g., machine learning models, deep learning models, statistical models, algorithms, etc.) for forecasting energy utilization of charging stations to determine charging station allocation. The utilization forecast computing device 102 may generate training data for the models based on data including but not limited to: historical utilization data, generated synthetic utilization data, data related to customers, stores and a neighborhood of each store. The utilization forecast computing device 102 trains the models based on their corresponding training data, and stores the models in a database, such as in the database 116 (e.g., a cloud storage). The models, when executed by the utilization forecast computing device 102, allow the utilization forecast computing device 102 to generate EV utilization forecasts.

In some examples, the utilization forecast computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the utilization forecast computing device 102 may generate forecasted utilization data.

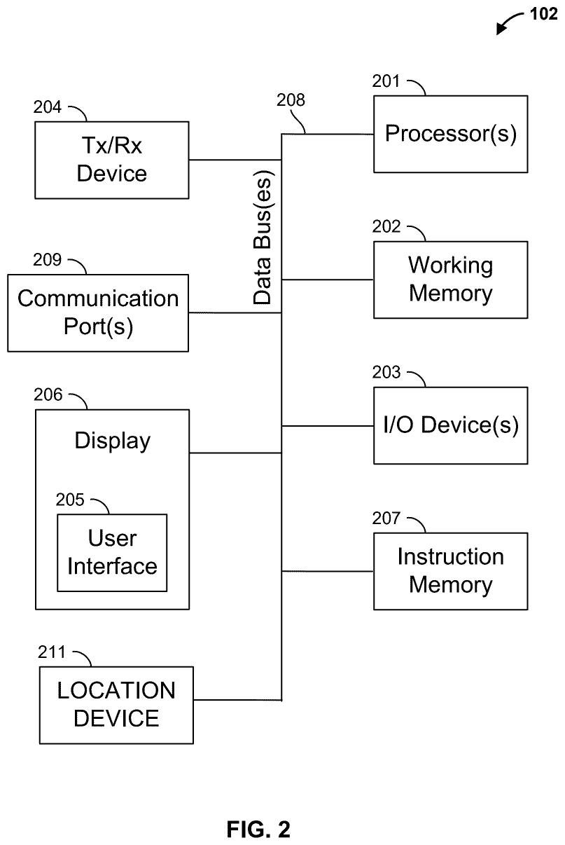

FIG. 2 illustrates a block diagram of a utilization forecast computing device, e.g. the utilization forecast computing device 102 of FIG. 1, in accordance with some embodiments of the present teaching. In some embodiments, each of the utilization forecast computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the utilization forecast computing device 102 can be combined, omitted, and/or replicated. In addition, it will be appreciated that additional elements other than those illustrated in FIG. 2 can be added to the utilization forecast computing device 102.

As shown in FIG. 2, the utilization forecast computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the utilization forecast computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CM P), a network processor, an input/output (I/O) processor, a media access control (M A C) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the utilization forecast computing device 102 can include a single memory unit configured to operate as both instruction memory and working memory. Further, although embodiments are discussed herein including non-volatile memory, it will be appreciated that the utilization forecast computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the utilization forecast computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the utilization forecast computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the utilization forecast computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the utilization forecast computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the utilization forecast computing device 102 may determine a local geographical area (e.g., town, city, state, etc.) of its position.

In some embodiments, the utilization forecast computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

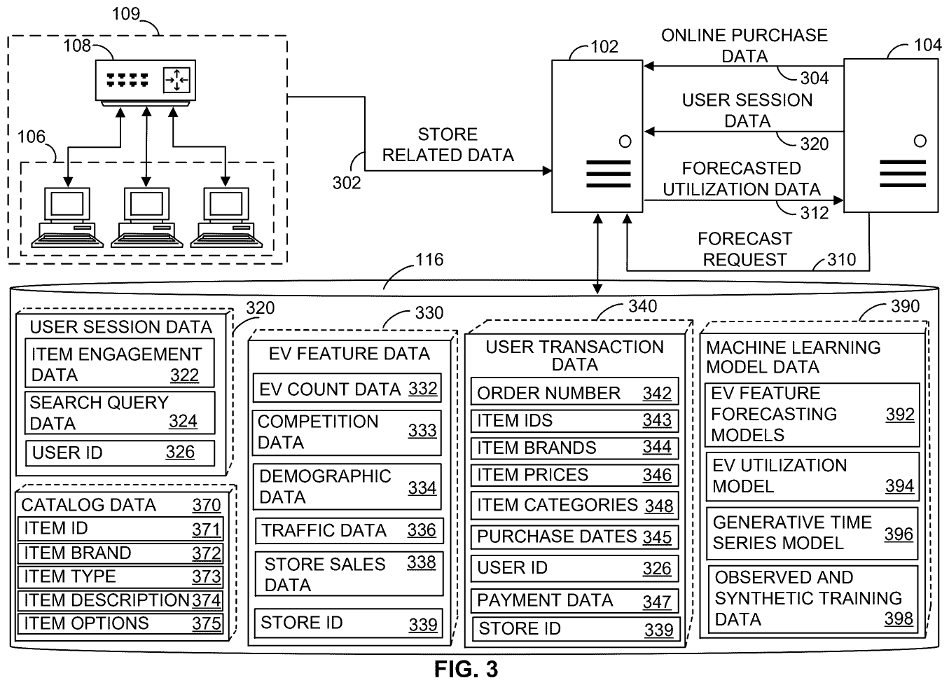

FIG. 3 is a block diagram illustrating various portions of a system for forecasting energy utilization of charging stations to determine charging station allocation, e.g. the system shown in the network environment 100 of FIG. 1, in accordance with some embodiments of the present teaching. As indicated in FIG. 3, the utilization forecast computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, charging session data 324, and user ID 326 (e.g., a customer ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The charging session data 324 may identify a set of steps where a user connects to a charging equipment, charges the car, makes payment, and then moves away, which may be considered equivalent to one charging event for one user to one car at one time.

The utilization forecast computing device 102 may also receive online purchase data 304 from the server 104, which identifies and characterizes one or more online purchases, such as purchases made by the user and other users via a retailer's website hosted by the server 104. The utilization forecast computing device 102 may also receive store related data 302 from the store 109, which identifies and characterizes one or more in-store purchases. In some embodiments, the store related data 302 may also indicate other information about the store 109. In some embodiments, the store purchases can be used in aggregate to determine e.g. total sales in a store, to be used for utilization forecast.

The utilization forecast computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 339 for the corresponding in-store purchase, or for the pickup store or shipping-from store associated with the corresponding online purchase. In some embodiments, all user transaction data 340 related to a store are aggregated to be used for utilization forecast.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.). In some embodiments, not all data in the database 116 are used for utilization forecast.

The database 116 may also store EV feature data 330, which may identify data of various features related to EV. The EV feature data 330 may identify: EV count data 332 identifying EV counts at a location; competition data 333 identifying charging competition at the location; demographic data 334 identifying demographic characteristic of the location; traffic data 336 identifying traffic at the location, e.g. street traffic at the location and footfalls of a store at the location; store sales data 338 identifying sales data of a store at the location; and store ID 339 for a store at the location. Each of these EV feature data 330 can be associated with a respective given time period, e.g. a past time period or a future time period. In some embodiments, these EV feature data 330 are at different granularities, e.g. monthly vs. yearly data, zip code, state vs. national levels.

The database 116 may also store machine learning model data 390 identifying and characterizing one or more models and related data for forecasting energy utilization of charging stations to determine charging station allocation. For example, the machine learning model data 390 may include: EV feature forecasting models 392, an EV utilization model 394, a generative time series model 396, and observed and synthetic training data 398.

The EV feature forecasting models 392 correspond to various EV related features associated with the EV feature data 330. Each of the EV feature forecasting models 392 is used to model a corresponding EV related feature, and compute a forecasted feature value for the corresponding EV related feature. An EV feature forecasting model may be a machine learning model developed based on diverse datasets. For example, an EV feature forecasting model corresponding to EV count feature may be developed by leveraging hierarchical, geographical, and linear/non-linear relationships in diverse datasets to forecast a long term EV count at a location in a future time period. The datasets may include, e.g.: monthly EV sales data in all states, yearly EV registration data from all states, national EV count yearly forecast, demographic attributes and vehicle ownership of population in various locations.

The EV utilization model 394 may be used to forecast expected energy utilization for EV charging stations at a location in a future time period. These EV charging stations may not have been installed yet. The expected energy utilization can be used to determine whether it is worthwhile to open one or more EV charging stations at the location, e.g. at a retailer's store of the location.

In some examples, the EV utilization model 394 may include one or more machine learning models trained based on training data. The training data may include both actual observed utilization data of some existing EV charging stations associated with the retailer during a past time period, and synthetic utilization data generated based on the actual utilization data using a generative time-series model. In some examples, the existing EV charging stations are located at locations other than the location of interest. In some examples, a length of the past time period is shorter than a length of the future time period.

The EV utilization model 394, after being trained, can forecast EV utilization based on forecasted feature values for the corresponding EV related features. For example, the EV utilization model 394 can determine interrelationships between the EV feature forecasting models 392 corresponding to the EV related features; and integrate all of the forecasted feature values based on the interrelationships. The interrelationships may include: hierarchical, geographical, and linear/non-linear relationships.

The generative time series model 396 may include a time series model used to generate synthetic utilization data based on the observed utilization data. For example, the generative time series model 396 may be generated based on a modification of a TimeGAN model. For example, the generative time-series model is trained to minimize a combination of a mean squared error (MSE) reconstruction loss as in a traditional TimeGAN model and a feature-based gradient loss to take care of each EV related feature. The generative time-series model is trained to generate time series conditioned on static confounders based on an attention layer in the model. In some embodiments, the generative time series model 396 may include a sub-model in the EV feature forecasting models 392 or the EV utilization model 394.

The observed and synthetic training data 398 may include data utilized for training one or more of the EV feature forecasting models 392, the EV utilization model 394, and the generative time series model 396. In some examples, the observed and synthetic training data 398 may be formed based on: actual utilization data of some existing EV charging stations associated with a retailer during a past time period, and synthetic utilization data generated based on the actual utilization data using a generative time-series model, e.g. the generative time series model 396. In some examples, the observed and synthetic training data 398 comprises the following data at different granularities associated with the location during a past time period: demographic data, proximity to freeways, street traffic data, store footfall data, store attribute data, charging competition data, EV count data, and store sales data.

In some examples, the observed and synthetic training data 398 is updated based on updated EV feature data and/or at least one key predictor of interest inferred from external utilization data. In some embodiments, the machine learning model data 390 includes any number of the EV feature forecasting models 392, the EV utilization model(s) 394, and the generative time series model(s) 396.

In some examples, the utilization forecast computing device 102 receives a forecast request 310 from the server 104. The forecast request 310 may seek expected utilization of EV charging stations at a location in a future time period. In some examples, a store of a retailer is located at the location, and the forecasted utilization data is provided to the retailer to determine whether and when to install a new EV charging station associated with the store at the location. In some embodiments, the new EV charging station may be installed to target EV owners in a neighborhood of the store, e.g. a region around the store with a radius of 5 miles or 10 miles. In some embodiments, the new EV charging station may also be installed to target EV drivers passing through the location on major traffic routes e.g. throughfare, freeway, etc., to help capturing a set of distant customers who would otherwise not purchase from the store because they do not live in the vicinity of the store.

In some embodiments, the utilization forecast computing device 102 may determine at least one EV related feature based on the forecast request, and compute at least one forecasted feature value for the at least one EV related feature associated with the location in the future time period, e.g. based on the EV feature forecasting models 392. Using a utilization model, e.g. the EV utilization model 394, the utilization forecast computing device 102 can generate forecasted utilization data based on the at least one forecasted feature value. In response to the forecast request 310, the utilization forecast computing device 102 transmits the forecasted utilization data 312 to the server 104.

In some embodiments, the utilization forecast computing device 102 may assign one or more of the above described operations to a different processing unit or virtual machine hosted by one or more processing devices 120. Further, the utilization forecast computing device 102 may obtain the outputs of the these assigned operations from the processing units, and generate the forecasted utilization data 312 based on the outputs.

In some embodiments, the forecast request 310 may be transmitted from a store, e.g. the store 109, to seek expected utilization of a potential new EV charging station at the store in a future time period. The utilization forecast computing device 102 will generate and transmit the forecasted utilization data 312 to the store 109 accordingly.

In some embodiments, the utilization forecast computing device 102 may automatically update the forecasted utilization data 312. For example, based on a configuration, an update request, or a predetermined periodic time interval, the utilization forecast computing device 102 can collect updated EV feature data and run the utilization model again to generate updated forecasted utilization data.

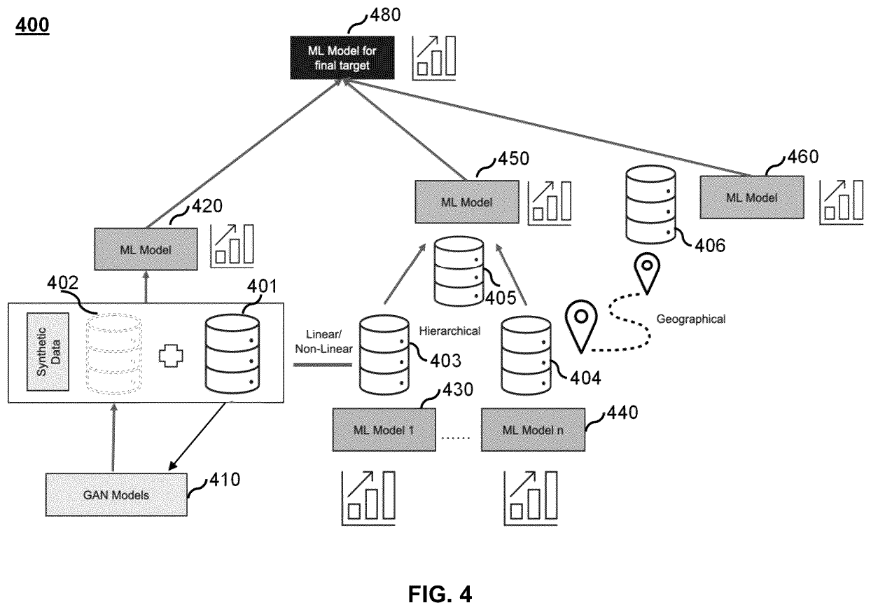

FIG. 4 illustrates an exemplary scheme 400 of a utilization forecast model, in accordance with some embodiments of the present teaching. In some embodiments, the utilization forecast model can be generated and applied by one or more computing devices, such as the utilization forecast computing device 102, and/or the cloud-based engine 121 of FIG. 1.

As shown in FIG. 4, the scheme 400 includes various sub-models 410, 420, 430, 440, 450, 460, 480, and various datasets 401, 402, 403, 404, 405, 406. The data in the datasets 401, 402, 403, 404, 405, 406 may come from different sources and may be at different granularities. The models 410, 420, 430, 440, 450, 460, 480 may be machine learning (ML) models for generating, combining and/or integrating the data in these datasets 401, 402, 403, 404, 405, 406.

In some embodiments, the utilization forecast model provides long-term utilization forecasts for EV utilization (e.g. in terms of kWh energy consumed) by combining the data from multiple sources with varied granularities. A reliable forecast can be generated by building numerous forecasting models 410, 420, 430, 440, 450, 460, 480, capturing the interrelationships among these models, and subsequently generating forecasts through the combination of the various models.

In one example shown in FIG. 4, the dataset 401 includes limited observed data, e.g. utilization data of limited existing EV charging stations in a limited history. The ML model 410 in this example is a generative adversarial network (GAN) model used to generate synthetic data in the synthetic dataset 402 based on the observed data in the dataset 401. As such, the ML model 420 may be trained based on training data including both the limited observed data and the representative synthetic data.

In addition, the utilization forecast model can incorporate multiple internal and external signs (including some black box signals), and combine the outcomes derived from many models. In some examples, the internal signs for a retailer include data from: membership information of customers of the retailer, information of vehicles serviced by an auto center associated with the retailer, information of vehicles used by the retailer for delivery, all stores (physical stores and online stores) related information of the retailer, all transaction information of the retailer, etc. In some examples, the external signs for the retailer include data that are outside of the retailer's control, and are publicly available to access or buy by the retailer. In some embodiments, the utilization forecast model integrates heterogeneous datasets for individual features at different granularities for robust long-term forecast.

In one example shown in FIG. 4, the models 430, 440 are used to generate feature data in the datasets 403, 404, respectively, e.g. based on data from external public sources. The data in the datasets 403, 404 may be associated with different EV features and may be at different granularity levels.

There are different interrelationships among data in the datasets 401, 402, 403, 404, 405, 406. For example, the dataset 403 may have a linear or non-linear relationship with the dataset 401. The dataset 405 has a higher or lower hierarchy than the datasets 403, 404. In some examples, the dataset 405 includes data at store level, while the datasets 403, 404 include data at zip code level, state level or national level. In some examples, the dataset 405 includes daily data, while the datasets 403, 404 include monthly data or yearly data.

In one example shown in FIG. 4, the dataset 406 has a geographical location relationship with the dataset 404. In some examples, the dataset 406 includes data at store level, while the dataset 404 includes data at zip code level. In some embodiments, one store covers an area including multiple zip codes. In some embodiments, one zip code covers multiple stores.

In one example shown in FIG. 4, data coming from different sources and having different granularities are all converted to store level data. The model 480 is used to collect data from the models 420, 450, 460, all at store level and forecast a final target, e.g. the long-term EV utilization at store level in a future time period. In some embodiments, the system can first convert and integrate all data into a same granularity, e.g. at state level and yearly data, and then convert the state level data to desired granularity, e.g. at store level and daily data.

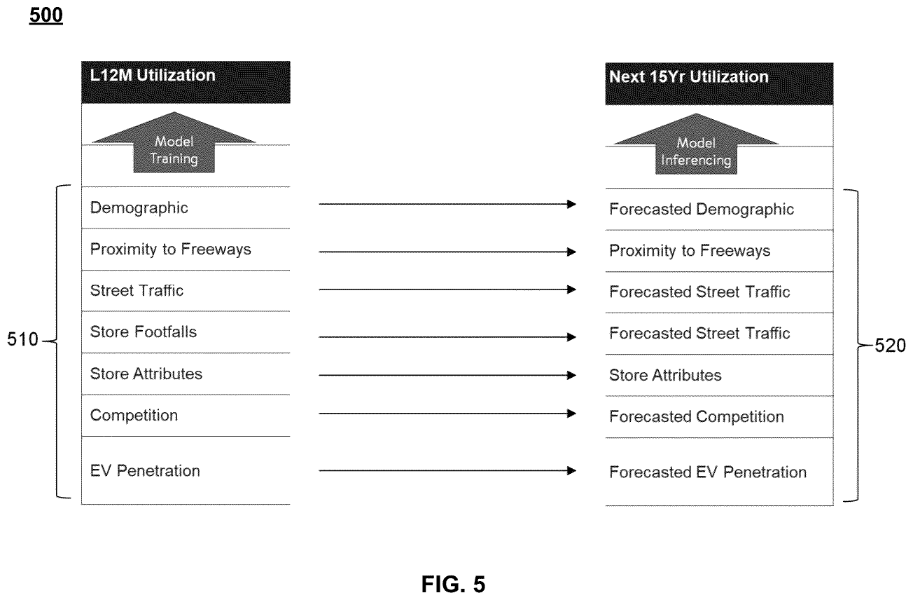

FIG. 5 illustrates an exemplary process 500 for forecasting features associated with a utilization forecast model, e.g. the utilization forecast model shown in FIG. 4, in accordance with some embodiments of the present teaching. In some embodiments, the process 500 can be carried out by one or more computing devices, such as the utilization forecast computing device 102, and/or the cloud-based engine 121 of FIG. 1.

In some embodiments, during a training stage of the utilization forecast model, the utilization model learns the relationships between observed utilization data from some existing locations and underlying driving factors 510. In one example shown in FIG. 5, the underlying driving factors 510 include the following data at different granularities associated with a location during a past time period: demographic data, proximity to freeways, street traffic data, store footfall data, store attribute data, charging competition data, and EV penetration or count data. In some examples, the past time period is for last 12 months.

In some embodiments, the driving factors 510 are forecasted for a long-term, e.g. next 10 years, 15 years or 20 years, to generate forecasted driving factors 520. The forecasted driving factors 520 may be generated based on respective forecasting models, e.g. one of the sub-models 410, 420, 430, 440, 450, 460 as shown in FIG. 4.

In one example shown in FIG. 5, the demographic data is used to generate forecasted demographic data in the long term; the proximity to freeways does not change in the long term; the street traffic data and the store footfall data are both used to generate forecasted street traffic for the location in the long term; the store attribute data may or may not change in the long term; the charging competition data is used to generate forecasted competition data in the long term; and the EV penetration data is generated to generate forecasted EV penetration data in the long term.

In some embodiments, during an inference stage of the utilization forecast model, the utilization model uses the learned relationship during the training stage to forecast EV utilization for the long-term based on the forecasted driving factors 520.

In some embodiments, assuming the utilization forecast model has a linear regression structure, the EV utilization for a given Year can be expressed as:

$${Utilization}_{Year} = F ( {Coeff}^{1} * {Factor}_{Year}^{1} , … , {Coeff}^{N} * {Factor}_{Year}^{N} ) , \qquad ( 1 )$$

where N driving factors are combined with corresponding N coefficients. These N coefficients and the function F are learned during a training stage of the utilization forecast model.

For each factor, e.g. Factor k, its long term forecast at Year+L can be expressed as:

$${Factor}_{Year + L}^{k} = G ( {Factor}_{Year}^{k} , … ) , \qquad ( 2 )$$

where the function G is learned during a training of a corresponding machine learning model for forecasting the Factor k.

Then the long term EV utilization at Year+L can be expressed as:

$${Utilization}_{Year + L} = F ( {Coeff}^{1} * {Factor}_{Year + L}^{1} , … , {Coeff}^{N} * {Factor}_{Year + L}^{N} ) , \qquad ( 3 )$$

where the N forecasted driving factors are combined with the same corresponding N coefficients under the same F function as in Equation (2).

In some embodiments, the forecast of EV penetration (or EV growth or EV count) is developed by leveraging hierarchical, geographical, and linear/non-linear relationships in diverse datasets and using various models and algorithms. In some embodiments, the datasets used to develop a long term EV count forecast model include but not limited to: monthly sales data for all states for EVs, yearly registration data for all states for EVs, national EV count yearly forecast from multiple external benchmark sources, demographic attributes and vehicle ownership of population living in neighborhoods of stores of a retailer.

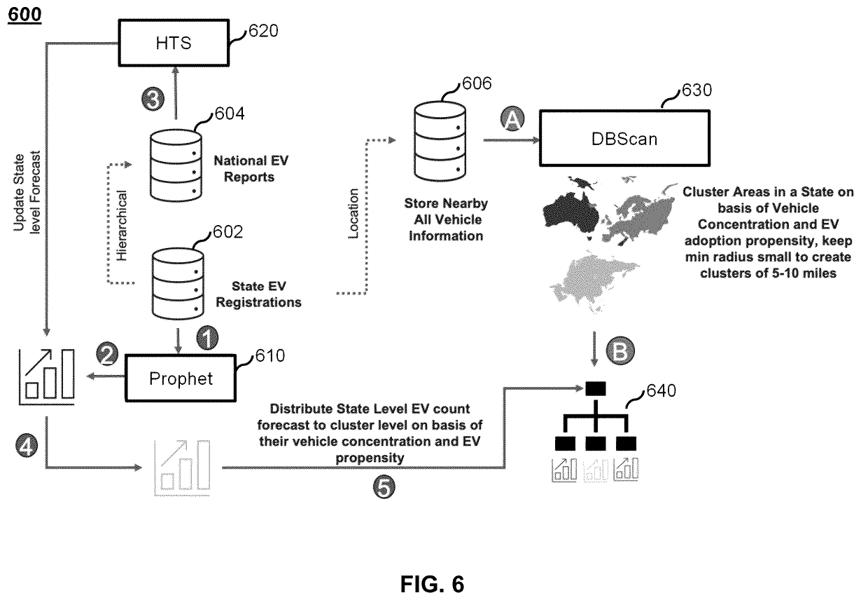

FIG. 6 illustrates an exemplary process 600 for forecasting EV count growth at store neighborhood level, in accordance with some embodiments of the present teaching. In some embodiments, the process 600 can be carried out by one or more computing devices, such as the utilization forecast computing device 102, and/or the cloud-based engine 121 of FIG. 1. In some embodiments, the process 600 includes two process flows: a first process flow including steps 1˜5, and a second process flow including steps A and B. The two process flows may be performed in parallel.

As shown in FIG. 6, the first process flow starts at step 1, where state level yearly EV registration is forecasted for a long term (e.g. 15 years). In some examples, a Prophet time-series forecasting model 610 is used to forecast the long term state level EV registrations, e.g. with logistic growth function and based on historical EV sales data or state level EV registrations 602.

In some examples, the Prophet time-series forecasting model 610 helps to: model “logistic growth” such that EV count saturates at a specified value more reflective of the observed trend in EV count and typical trend in adoption emerging technologies, and incorporate external benchmarks at intermediate points to guide “trend” through intermediate “changepoints” to model different patterns in the EV growth projection.

In some examples, these intermediate changepoints are discovered through: observing year to year EV count growth trends in multiple international markets, finding the most similar international market for the observed year to year EV count growth for a state, and inferring intermediate EV count such that state growth follows the growth of representative international market. This can help to model growth trend of states to reflect different levels of historical growth and current maturity in terms of EV adoption (or registration) by comparing to external markets where similar pattern has been observed. As such, forecasted EV sale is converted into EV stock (or registrations) through historical EV registration before start of the forecast duration.

Then at step 2 in the first process flow, the system enriches or updates state level forecast through publicly available benchmarks on EV count growth from external agencies or publications, as the long-term forecasts are inherently difficult in extremely dynamic industry with limited history such as EV. In some examples, these benchmarks are available only at national level. As such, a hierarchical time series (HTS) model 620 is used to model the relationship between national level EV benchmark counts from national EV reports 604 and states level forecasted counts, at step 3 in the first process flow. In some examples, HTS is particularly useful given the exponential trend of EV adoption and almost no consensus among different predictions. By integrating information from external benchmarks at step 4 in the first process flow, the state level forecast becomes more robust and reliable.

In some embodiments, the system computes, at step A in the second process flow, the EV count around a store's neighborhood using the above state level forecast. In absence of direct count of EV around the stores, the system can employ combination of demographic information and information from existing vehicle ownership (EV or not), including store nearby all vehicle information 606. In some embodiments, first, all eligible locations (e.g. locations of existing stores) within each state are clustered using a clustering model, e.g. a DB Scan model 630, based on their latitude and longitude locations. Then, the system can compute the total count of vehicles (electric or combustion engine) within each such cluster. These counts as proportion to total vehicular count in the state provide baseline share of vehicles in the cluster among total vehicles in the state. Subsequently, the system adjusts vehicle share in the cluster to estimate EV share within each cluster using demographic attributes linked to EV (e.g. environmental awareness, income, etc.). For instance, a cluster with a population higher than average income and higher than average environmental awareness may have an EV share higher than overall vehicle share. This EV share across all clusters in a state can then be transformed to EV penetration percentage, e.g. using a SoftMax model, so that the sum of all EV penetration in a state equals 100%.

At step B in the second process flow, the system clusters areas in a state based on: the EV penetration percentage and EV adoption propensity. For example, each area cluster in the state has a minimum radius between 5 and 10 miles, which is configurable by users. When two clusters have an overlap, a same EV count in the overlap may be assigned to both clusters.

At step 5 in the first process flow, the system distributes state level EV count forecast to cluster level based on their EV penetration percentage and EV adoption propensity. The local level growth of EVs can then be computed by a model 640, based on the results from the step 5 and the step B.

Thus, the system can obtain long-term EV count forecast for each location despite not having granular EV count data, by forecasting EV for each state, adjusting state level forecasts using external benchmarks at national level, and rolling-down state forecast to each store.

In some embodiments, model driving factors other than the EV count can be forecasted as well. Utilization at a location is driven by demographic characteristic of neighborhood, traffic around store, observed footfall at location such as retail store, and charging competition around store neighborhood, apart from the EV count in the neighborhood. In some embodiments, the system utilizes more than 50 such driving factors across these categories. These driving factors are also forecasted for the long term.

One goal of the utilization model is to learn the relations between various underlying predictors (or driving factors) and the observed utilization from existing locations, and then use the learned model to infer future utilization based on future values of the underlying predictors. Given necessity of the out of time (in the future) and out of sample (expected utilization in future will be higher than that observed as EV count grows) prediction, in some embodiments, the system trains multiple-linear regression model to predict expected monthly kWh for EV charging stations at a given retail location.

In some examples, an ensemble linear regression model is preferred. Tree based models are unable to predict utilization more than maximum of historical observed utilization despite manifold (e.g. 10˜100+) increase in the EV count and other underlying predictors.

In some embodiments, the system augments limited observations with synthetic training data. In some examples, the observed monthly utilizations are from limited locations (e.g. ˜200), which are found to be very scarce compared to dimensionality of predictors forcing the problem to underspecified space in regression prediction space. Moreover, these locations do not even cover all US states sufficiently which vary in their EV adoption maturity and policy framework which drive EV growth. Since existing observations do not capture all patterns present in the data, the system mitigates these limitations through synthetic data through a generative time series model, e.g. a modified TimeGAN model. A TimeGAN model is designed specifically for generating synthetic time series datasets that include both temporal and static characteristics. The TimeGAN model has the ability to generate synthetic time series data along with static covariates. But there are shortcomings on the data generated by existing TimeGAN models.

In situations when the data source has substantial and abundant information but limited history, the conditional generation of synthetic data on strategic parameters (e.g., EV count, urban index of location, retail sales, etc.) aids in the development of a well-grounded forecast model. It is not possible to obtain samples from the existing TimeGAN model conditioned on strategic features. The process of conducting conditional sampling is not provisioned in the traditional TimeGAN model. In addition, the TimeGAN model minimizes mean reconstruction loss, but does not minimize loss on individual strategic parameters, which are of special importance to capture strategic relations between key features.

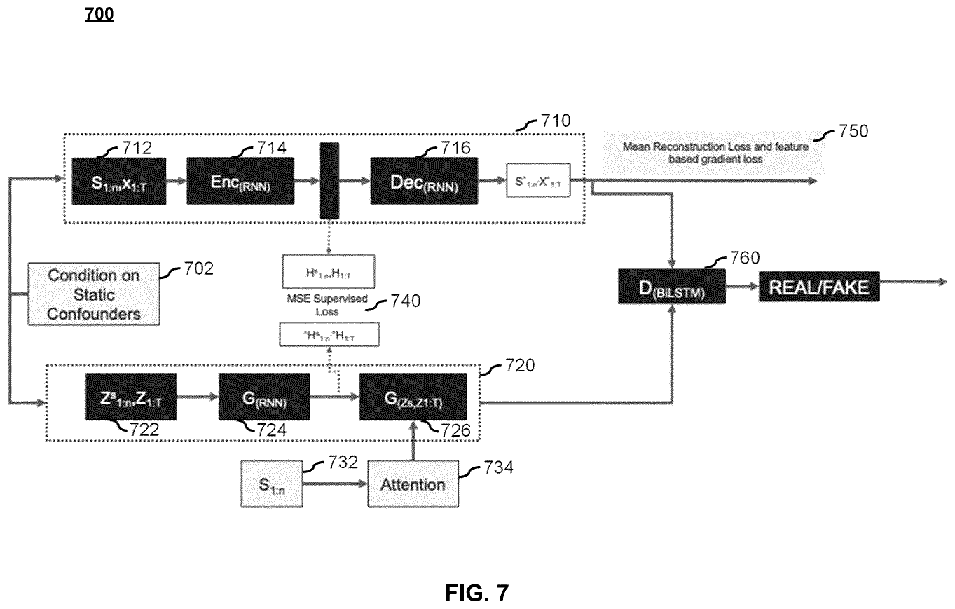

As such, the system utilizes a modified or improved version of TimeGAN model to generate synthetic data conditioned on strategic parameters (e.g., EV count, urban index of location, retail sales, etc.). FIG. 7 illustrates an exemplary structure of a modified TimeGAN model 700, in accordance with some embodiments of the present teaching. In some embodiments, the modified TimeGAN model 700 can be implemented as the model 410 in FIG. 4.

As shown in FIG. 7, the modified TimeGAN model 700 includes a real data section 710 and a synthetic data section 720. The real data section 710 includes a real data input 712 that includes both a static feature S and a temporal feature X. The real data section 710 further includes an encoder 714 configured to encode the real data input 712, and a decoder 716 configured to generate a reconstructed real data.

The synthetic data section 720 includes random noise data 722 corresponding to the real data input 712. The synthetic data section 720 further includes a generator 724 including a recurrent neural network (RNN) configured to generate synthetic time series 726 based on a tuple of static and temporal random feature vectors.

The generator 724 attempts to generate synthetic data that is similar to the real data input 712. The modified TimeGAN model 700 also includes a discriminator 760 configured to determine if the generated synthetic data is real or fake. The real and synthetic time series are used to calculate a supervised loss 740 based on mean squared error (MSE).

In some embodiments, along with the MSE reconstruction loss 740, the system also incorporates feature based gradient loss into both the encoder 714 and the decoder 716, resulting in an enhanced quality of the embeddings. In some embodiments, the following loss function is added into the MSE reconstruction function:

$${L}_{feature} = {\sum }_{i = 1}^{n} {\sum }_{j = 1}^{n} {( {S}_{i} - {S}_{j}^{′} )}^{2} \qquad ( 4 )$$

where S_{1 . . . n} represents actual features and S_{1 . . . n}′ represents reconstructed features and L_{feature} represents reconstruction loss for each feature. These loss functions for each individual feature can make sure that differences in reconstruction even at individual feature level are considered while training the modified TimeGAN model 700. As such, rather than merely minimizing the MSE reconstruction loss 740, the modified TimeGAN model 700 is trained to minimize a combination (e.g. average combination or weighted combination) of the MSE reconstruction loss and feature based gradient loss 750. This ensures that the modified TimeGAN model 700 is trained to minimize errors of both temporal features and static features.

In some embodiments, rather than generating both static confounders and time series feature from a joint distribution, the modified TimeGAN model 700 is trained to generate both static confounders and time series feature from a joint distribution based on conditions on static confounders 702. As such, this model is trained to jointly generate both static confounders and time series features, but this joint distribution is conditioned on static confounders specified at the time of generation. Hence if user wants to generate static features and time series for specific strategic parameters like high EV count, high store sales, it is possible by specifying these conditions at the time of generation. It is crucial for the modified TimeGAN model 700 to comprehend the influence of static confounders on time series. To achieve this, attention layers 734 have been incorporated between the static confounders 732 and the generated time series 726.

The conditions 702 can control what features to change and how to change them, during the random data based generation of the synthetic time series. In some examples, the conditions 702 may be applied to generate data for a store in an urban area where crime is low, EV count is high but competition is low. The condition 750 about feature based gradient loss allows to provide constraints between maximum value allowed values of some features and avoid of the violation of basic constructs. In some examples, without feature loss 750 on the static confounders, the generated data may include 10 total charging stations and 12 fast charging stations, which is a violation of the static confounders.

The system can compute attention based score between static confounders (S) and embedding/GAN hidden layer corresponding to time series H_{1:T}. Given vₛₜ=WᵥHₜ∈R, where t∈{1, 2, . . . , T} and s∈{1, 2, . . . , S} and Wᵥ∈R^{t×s} is an attention weight, the attention based score is computed as:

$${Score}_{st} = {\sum }_{i = 1}^{i = s} {\sum }_{j = 1}^{j = t} {e}_{st}^{v} / ( 1 + {e}_{st}^{v} ) \qquad ( 5 )$$

where the attention based score is computed between hidden layer (H_{1:T}) and the static confounders {1, 2, . . . , S}, such that sum of attention based score for each static confounder across one time series should be one, as:

$${\sum }_{i = 1}^{i = s} {\sum }_{j = 1}^{j = t} {Score}_{ij} = 1.$$

In this way, the static confounders 732 are smoothed to all T components of generated time series 726. Therefore, the attention matrix can align the impact of static confounders on Hidden units corresponding to time series (1:T) and can generate appropriate time series per given static confounders.

As such, given a noise vector z 722 and vector of static confounders 732, the generator G 724 can generate a calibrated Hidden State H^{˜} for time series 726 conditioned on static confounders vector 732.

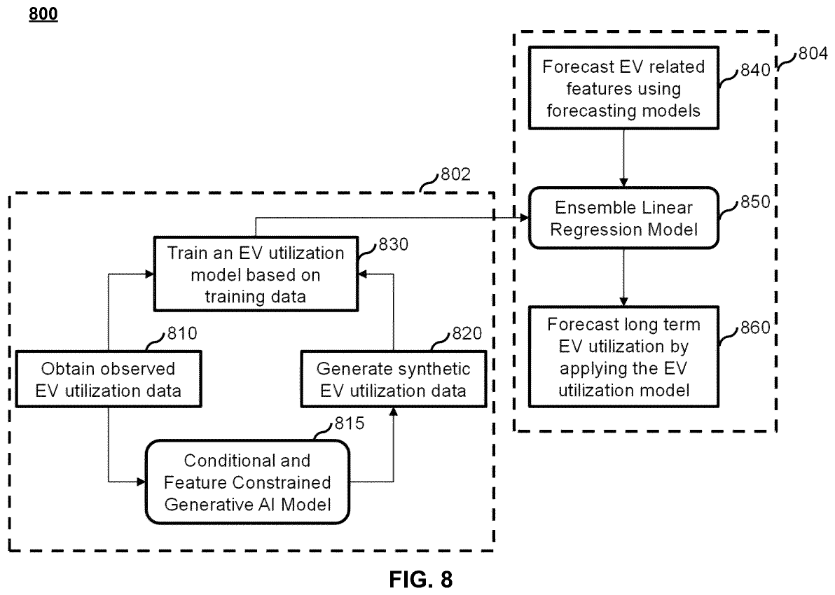

FIG. 8 illustrates an exemplary framework 800 for forecasting energy utilization of charging stations, in accordance with some embodiments of the present teaching. In some embodiments, the framework 800 can be carried out by one or more computing devices, such as the utilization forecast computing device 102, and/or the cloud-based engine 121 of FIG. 1. As shown in FIG. 8, the framework 800 includes two processes: a process 802 performed at a training stage of a utilization model, and a process 804 performed at an inference stage of the utilization model.

The process 802 starts from operation 810, where observed EV utilization data is obtained, e.g. in terms of kWh during a past time period like last 6 or 12 months. Then, based on a generative AI model 815 that is conditional and feature constrained, synthetic EV utilization data is generated at operation 820. In some examples, the generative AI model 815 may be implemented as the modified TimeGAN model 700 in FIG. 7. At operation 830, an EV utilization model is trained based on training data, which includes both the observed EV utilization data and the synthetic EV utilization data. The trained model may be stored in a database, e.g. the database 116, for future use during the inference stage.

In some embodiments, the EV utilization model includes multiple machine learning models corresponding to multiple EV features or EV utilization driving factors, respectively. The EV utilization model is trained to learn the interrelationships between the machine learning models corresponding different driving factors, and the utilization model is generated based on the interrelationships, which may include: hierarchical, geographical, and linear/non-linear relationships. In the example shown in FIG. 8, the trained EV utilization model is in form of an ensemble linear regression model 850, that can combine all of the machine learning models corresponding to multiple EV features or EV utilization driving factors. The ensemble linear regression model 850 uses interaction and degree features to capture non-linearity in relationships between driving factors and utilization target, while still keeping the linear model form.

During an inference stage of the ensemble linear regression model 850, the process 804 starts from operation 840, where all underlying drivers or driving factors are forecasted for the long term. For example, the underlying driving factors include: EV count at the location in the future time period, charging competition in a neighborhood of the store at the location in the future time period, demographic characteristic of the neighborhood in the future time period, traffic around the store in the future time period, and sales data at the store in the future time period. Based on the forecasts performed at the operation 840, a forecasted feature value is computed for each EV related feature or each driving factor, e.g. based on a corresponding machine learning model. For example, a process for forecasting the driving factor of EV count has been described above referring to FIG. 6. Similar processes can be applied to forecast other driving factors in the long term, during which the EV utilization forecast is desired. Then at operation 860, the long term EV utilization is forecasted by applying the EV utilization model, e.g. the ensemble linear regression model 850, based on the forecasted feature values of the driving factors in the long term, e.g. next 15 years or 20 years.

In some embodiments, the system can leverage external black box utilization forecasts from various vendors to improve the model predictions. Given the limited history and dynamic evolving nature of the business, the system tries to incorporate as many external insights as possible to guide the utilization forecast, while still maintaining the robustness, predictive performance, and transparency of the utilization model. Since these external forecasts themselves are derived through various methods each of which is unknown like a black box, the system can distil insights from these predicted utilization, without any underlying predictors (or driving factors), training data, training model, or ground truth used to train those models.

In some examples, the system has access to all relevant driving factors to forecast utilization except the real EV count around a store's neighborhood for which rigorous model is made leveraging multiple external and internal sources, which may not necessarily represent the reality. The system can train the utilization prediction regression model using training data available for the set of locations, for which utilization inference is made using external black box utilization as target. Using model learned weights across different categories of predictors (e.g. demographic, traffic, etc.) except for EV count, the system computes predicted utilization, and computes a difference between the predicted utilization and the target black box utilization. This difference is then attributed to contribution from EV count predictor, which is then normalized across states to match observed state level EV count, thereby deriving relative magnitude of store level EV count across locations. This can help to infer key predictor of interest (e.g. EV count) from external black box utilization predictions. The key predictor of interest and its associated weights or contribution to the external black box utilization may be used to update the long-term utilization forecast model that is described above.

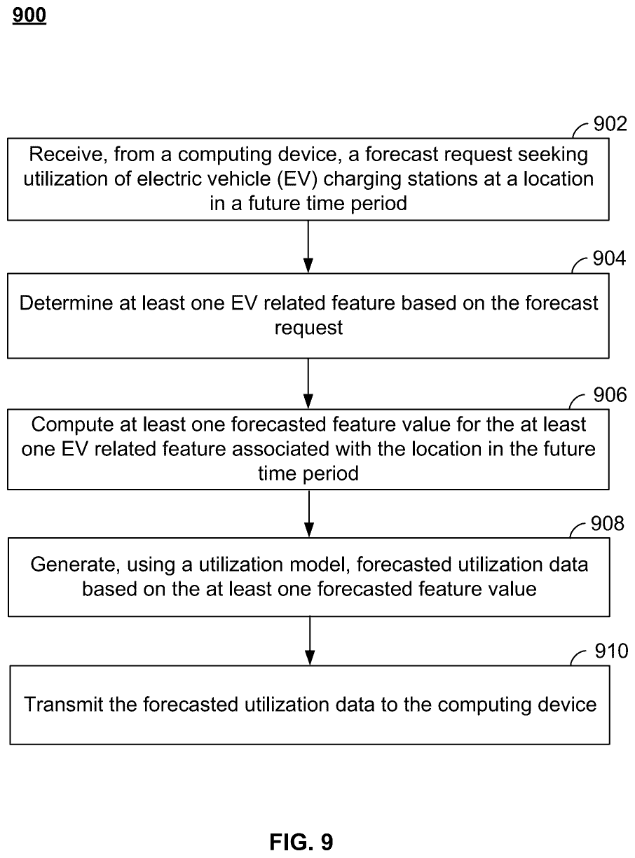

FIG. 9 is a flowchart illustrating an exemplary method 900 for forecasting energy utilization of charging stations to determine charging station allocation, in accordance with some embodiments of the present teaching. In some embodiments, the method 900 can be carried out by one or more computing devices, such as the utilization forecast computing device 102 and/or the cloud-based engine 121 of FIG. 1. Beginning at operation 902, a forecast request is received from a computing device, seeking utilization of EV charging stations at a location in a future time period. At operation 904, at least one EV related feature is determined based on the forecast request. At operation 906, at least one forecasted feature value is computed for the at least one EV related feature associated with the location in the future time period. At operation 908, using a utilization model, forecasted utilization data is generated based on the at least one forecasted feature value. The forecasted utilization data is transmitted at operation 910 to the computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a forecast request seeking utilization of electric vehicle (EV) charging stations at a location in a future time period,
determine at least one EV related feature based on the forecast request,
compute at least one forecasted feature value for the at least one EV related feature associated with the location in the future time period,
generate, using a utilization model, forecasted utilization data based on the at least one forecasted feature value, and
transmit the forecasted utilization data to a computing device.

2. The system of claim 1, wherein:
a store of a retailer is located at the location;
the forecasted utilization data is provided to the retailer to determine whether and when to install a new EV charging station associated with the store at the location; and
the at least one EV related feature comprises at least one of:
an EV count at the location in the future time period,
a charging competition in a neighborhood of the store at the location in the future time period,
a demographic characteristic of the neighborhood in the future time period,
a traffic around the store in the future time period, and
sales data at the store in the future time period.

3. The system of claim 2, wherein:
the at least one EV related feature includes a plurality of features at different granularities;
the at least one forecasted feature value includes a plurality of forecasted feature values for the plurality of features, respectively;
the processor is configured to integrate the plurality of forecasted feature values at different granularities to generate integrated feature data; and
the forecasted utilization data is generated using the utilization model based on the integrated feature data.

4. The system of claim 3, wherein the plurality of forecasted feature values are computed based at least in part by:
computing a forecasted feature value for each of the plurality of features based on a corresponding machine learning model.

5. The system of claim 4, wherein the utilization model is generated based at least in part by:
training a plurality of machine learning models corresponding to the plurality of features based on a training dataset;
determining interrelationships between the plurality of machine learning models corresponding to the plurality of features; and
generating the utilization model based on the interrelationships.

6. The system of claim 5, wherein the training dataset comprises:
actual utilization data of one or more existing EV charging stations associated with the retailer during a past time period; and
synthetic utilization data generated based on the actual utilization data using a generative time-series model.

7. The system of claim 6, wherein:
the one or more existing EV charging stations are located at locations other than the location;
a length of the past time period is shorter than a length of the future time period;
the generative time-series model is trained to minimize a combination of a mean squared error (MSE) reconstruction loss and a feature-based gradient loss; and
the generative time-series model is trained to generate time series conditioned on static confounders based on an attention layer.

8. The system of claim 2, wherein the EV count at the location in the future time period is computed based at least in part by:
computing, based on a time-series forecasting model, state level forecasts of yearly registration counts of EV in the future time period;
adjusting the state level forecasts using public benchmarks at a national level; and
computing the EV count at the location in the future time period based on the adjusted state level forecasts.

9. The system of claim 1, wherein the instructions, when executed, further cause the processor to:
obtain external utilization data for a set of locations;
compute predicted utilization data for the set of locations using the utilization model;
determine a difference between the external utilization data and the predicted utilization data;
infer at least one key predictor of interest from the external utilization data based on the difference; and
update the utilization model based on the at least one key predictor of interest.

10. A computer-implemented method, comprising:
receiving a forecast request seeking utilization of electric vehicle (EV) charging stations at a location in a future time period;
determining at least one EV related feature based on the forecast request;
computing at least one forecasted feature value for the at least one EV related feature associated with the location in the future time period;
generating, using a utilization model, forecasted utilization data based on the at least one forecasted feature value; and
transmitting the forecasted utilization data to a computing device.

11. The computer-implemented method of claim 10, wherein:
a store of a retailer is located at the location;
the forecasted utilization data is provided to the retailer to determine whether and when to install a new EV charging station associated with the store at the location; and
the at least one EV related feature comprises at least one of:
an EV count at the location in the future time period,
a charging competition in a neighborhood of the store at the location in the future time period,
a demographic characteristic of the neighborhood in the future time period,
a traffic around the store in the future time period, and
sales data at the store in the future time period.

12. The computer-implemented method of claim 11, wherein:
the at least one EV related feature includes a plurality of features at different granularities;
the at least one forecasted feature value includes a plurality of forecasted feature values for the plurality of features, respectively;
the computer-implemented method further comprises integrating the plurality of forecasted feature values at different granularities to generate integrated feature data; and
the forecasted utilization data is generated using the utilization model based on the integrated feature data.

13. The computer-implemented method of claim 12, wherein:
the plurality of forecasted feature values are computed based at least in part by computing a forecasted feature value for each of the plurality of features based on a corresponding machine learning model; and
the utilization model is generated based at least in part by:
training a plurality of machine learning models corresponding to the plurality of features based on a training dataset,
determining interrelationships between the plurality of machine learning models corresponding to the plurality of features, and
generating the utilization model based on the interrelationships.

14. The computer-implemented method of claim 13, wherein:
the training dataset comprises: actual utilization data of one or more existing EV charging stations associated with the retailer during a past time period, and synthetic utilization data generated based on the actual utilization data using a generative time-series model;
the one or more existing EV charging stations are located at locations other than the location;
a length of the past time period is shorter than a length of the future time period;
the generative time-series model is trained to minimize a combination of a mean squared error (MSE) reconstruction loss and a feature-based gradient loss; and
the generative time-series model is trained to generate time series conditioned on static confounders based on an attention layer.

15. The computer-implemented method of claim 11, wherein the EV count at the location in the future time period is computed based at least in part by:
computing, based on a time-series forecasting model, state level forecasts of yearly registration counts of EV in the future time period;
adjusting the state level forecasts using public benchmarks at a national level; and
computing the EV count at the location in the future time period based on the adjusted state level forecasts.

16. The computer-implemented method of claim 10, further comprising:
obtaining external utilization data for a set of locations;
computing predicted utilization data for the set of locations using the utilization model;
determining a difference between the external utilization data and the predicted utilization data;
inferring at least one key predictor of interest from the external utilization data based on the difference; and
updating the utilization model based on the at least one key predictor of interest.

17. A non-transitory computer readable medium having instructions stored thereon, wherein the instructions, when executed by at least one processor, cause at least one device to perform operations comprising:
receiving a forecast request seeking utilization of electric vehicle (EV) charging stations at a location in a future time period;
determining at least one EV related feature based on the forecast request;
computing at least one forecasted feature value for the at least one EV related feature associated with the location in the future time period;
generating, using a utilization model, forecasted utilization data based on the at least one forecasted feature value; and
transmitting the forecasted utilization data to a computing device.

18. The non-transitory computer readable medium of claim 17, wherein:
a store of a retailer is located at the location;
the forecasted utilization data is provided to the retailer to determine whether and when to install a new EV charging station associated with the store at the location;
the at least one EV related feature includes a plurality of features at different granularities; and
the at least one forecasted feature value includes a plurality of forecasted feature values for the plurality of features, respectively.

19. The non-transitory computer readable medium of claim 18, wherein:
the operations further comprise integrating the plurality of forecasted feature values at different granularities to generate integrated feature data;
the forecasted utilization data is generated using the utilization model based on the integrated feature data;
the plurality of forecasted feature values are computed based at least in part by computing a forecasted feature value for each of the plurality of features based on a corresponding machine learning model; and
the utilization model is generated based at least in part by:
training a plurality of machine learning models corresponding to the plurality of features based on a training dataset,
determining interrelationships between the plurality of machine learning models corresponding to the plurality of features, and
generating the utilization model based on the interrelationships.

20. The non-transitory computer readable medium of claim 17, wherein the operations further comprise:
obtaining external utilization data for a set of locations;
computing predicted utilization data for the set of locations using the utilization model;
determining a difference between the external utilization data and the predicted utilization data;
inferring at least one key predictor of interest from the external utilization data based on the difference; and
updating the utilization model based on the at least one key predictor of interest.
